(19) United States
(12) Patent Application Publication
(10) Pub. No.: US 2026/0183685 A1
(43) Pub. Date: Jul. 2, 2026

(54) FILTER DRYER COMPONENT AND FILTER DRYER

(71) Applicant: Danfoss A/S, Nordborg (DK)

(72) Inventors: Kumaran Chandran, Chennai (IN); Blooshee Paulraj, Nordborg (DK); Ramanan Kumar, Oragadam (IN)

(21) Appl. No.: 19/126,052

(22) PCT Filed: Dec. 11, 2023
(86) PCT No.: PCT/EP2023/085212

§ 371 Date: Apr. 30, 2025

(30) Foreign Application Priority Data
Jan. 6, 2023 (CN) 202320033146.0

(51) Int. Cl. B01D 29/96; B01D 17/02; B01D 29/90; B01D 29/92; B01D 35/30; F25B 41/20; F25B 43/00

(52) U.S. Cl. CPC B01D 29/96; B01D 17/02; B01D 29/902; B01D 29/925; B01D 35/30; B01D 2201/165; B01D 2201/347; F25B 41/20; F25B 43/003

(57) ABSTRACT

The disclosure discloses a filter dryer component, including a filter element housing, an inlet valve, an outlet valve and a bypass section, wherein the filter element housing has a fluid inlet and a fluid outlet, one or more filter elements being able to detachably installed in the filter element housing, the bypass section has a bypass channel therein, and the bypass channel has an entry port and an exit port in communication with each other, the inlet valve and the outlet valve are both T-shaped three-way ball valves, each defining two opposite ports and one side port, the two opposite ports of the inlet valve are respectively connected to a fluid entry connector and the fluid inlet of the filter element housing, the side port of the inlet valve is connected to the entry port of the bypass channel, the two opposite ports of the outlet valve are respectively connected to a fluid exit connector and the fluid outlet of the filter element housing, and the side port of the outlet valve is connected to the exit port of the bypass channel. The filter dryer component has reduced volume and weight, and saves manufacturing cost. The disclosure also discloses a filter dryer.

### CROSS-REFERENCE TO RELATED APPLICATIONS

This application is a National Stage application of International Patent Application No. PCT/EP2023/085212, filed on Dec. 11, 2023, which claims priority to Chinese Patent Application No. 202320033146.0, filed on Jan. 6, 2023, each of which is hereby incorporated by reference in its entirety.

### TECHNICAL FIELD

The present invention relates to the fields of heating, ventilation and air conditioning, in particular to a filter dryer component as well as a filter dryer comprising the filter dryer component.

### BACKGROUND

Filter dryers are widely used in the fields of heating, ventilation and air conditioning. In a heating, ventilation or air conditioning system, a filter dryer filters and dries the refrigerant flowing through it.

Therefore, a filter dryer is usually provided with filter element(s) therein. The filter element, after being used for a period of time, may be polluted and blocked and needs to be replaced. Some filter dryers in the prior art are provided with a bypass channel, so that the corresponding system such as an air conditioning system can still operate while the filter element is being replaced. That is to say, when the maintenance personnel is replacing the filter element, the refrigerant does not pass through the filter element temporarily, but directly passes through the bypass channel. This is especially advantageous for large equipment or systems that need continuous operation.

However, existing filter dryers with a bypass channel still have the disadvantages of large volume and high cost.

### SUMMARY

To solve the above problems, according to a first aspect of the present invention, filter dryer component is proposed, characterized in comprising a filter element housing, an inlet valve, an outlet valve and a bypass section, wherein the filter element housing has a fluid inlet and a fluid outlet, one or more filter elements being able to detachably installed in the filter element housing,
the bypass section has a bypass channel therein, the bypass channel having an entry port and an exit port in communication with each other,
the inlet valve and the outlet valve are both T-shaped three-way ball valves, the inlet valve and the outlet valve each defining two opposite ports and one side port, a connecting line between the center points of the two opposite ports defining a linear axis, and the center point of the side port defining a side axis that is generally perpendicular to and intersects the linear axis, and wherein,
the two opposite ports of the inlet valve are respectively connected to a fluid entry connector and the fluid inlet of the filter element housing, and the side port of the inlet valve is connected to the entry port of the bypass channel,
the two opposite ports of the outlet valve are respectively connected to a fluid exit connector and the fluid outlet of the filter element housing, and the side port of the outlet valve is connected to the exit port of the bypass channel.

The filter dryer component according to the first aspect of the invention only needs two T-shaped three-way ball valves to switch the flow path of the refrigerant in the filter dryer component, that is, the flow path passing through the filter element housing or the flow path passing through the bypass channel, thus saving the cost. In addition, the two T-shaped three-way ball valves are able to be arranged close to the filter element housing, so the bypass channel can also be arranged close to the filter element housing. This makes it possible to reduce the volume and weight of the entire filter dryer component, and further reduce the manufacturing cost.

The filter dryer component according to the present invention may have one or more of the following features.

According to one embodiment, preferably, the filter element housing has a cylindrical cavity, the cylindrical cavity defining a cavity side face and two cavity end faces, the central axis of the cylindrical cavity defining a cavity axis, and wherein the fluid inlet of the filter element housing is arranged at the cavity side face, and the fluid outlet of the filter element housing is arranged at one of the cavity end faces.

The filter dryer component according to this embodiment, due to the arrangement of direction and position of its fluid inlet and fluid outlet, can occupy a smaller length in the direction of the cavity axis of the filter element housing, so the requirement for space during installation is lower.

According to one embodiment, preferably, one of the two opposite ports of the inlet valve is adjacently connected to the fluid inlet of the filter element housing, the linear axis of the inlet valve is generally perpendicular to and intersects with the cavity axis of the filter element housing, the side port of the inlet valve is arranged toward the side where the fluid outlet of the filter element housing is located, and the side axis of the inlet valve is generally parallel to the cavity axis of the filter element housing;
one of the two opposite ports of the outlet valve is adjacently connected to the fluid outlet of the filter element housing, the linear axis of the outlet valve is generally parallel to the cavity axis of the filter element housing, the side port of the outlet valve is arranged toward the side where the fluid inlet of the filter element housing is located, and the side axis of the outlet valve is generally parallel to the linear axis of the inlet valve;
the entry port of the bypass channel is adjacently connected to the side port of the inlet valve, and the exit port of the bypass channel is adjacently connected to the side port of the outlet valve, and the bypass channel extends in the plane formed by the cavity axis of the filter element housing and the linear axis of the inlet valve.

The filter dryer component according to this embodiment enables that, the cavity axis of the filter element housing, the respective linear axis and side axis of the inlet valve and the outlet valve, and the central axis of the bypass channel itself are generally located in the same plane, so that the volume of the filter dryer component is smaller and the manufacturing cost is lower.

According to one embodiment, preferably, one of the two opposite ports of the outlet valve is adjacently connected to the fluid outlet of the filter element housing, the linear axis of the outlet valve is generally parallel to the cavity axis of the filter element housing, and the side port of the outlet valve is arranged toward the side where the fluid inlet of the filter element housing is located;
wherein the inlet valve is arranged such that the side port of the inlet valve and the side port of the outlet valve are close to and facing each other, the linear axis of the inlet valve is generally parallel to the cavity axis of the filter element housing, and the bypass section is arranged between the inlet valve and the outlet valve, the side port of the inlet valve and the side port of the outlet valve in communication with each other via the bypass channel;
and wherein, the filter dryer component has an inlet side pipe arranged outside the filter element housing, the inlet side pipe communicating the fluid inlet of the filter element housing with one of the two opposite ports of the inlet valve that is closer to the fluid inlet of the filter element housing.

The filter dryer component according to this embodiment, by providing an inlet side pipe connecting the fluid inlet and the inlet valve outside the filter element housing, further reduces its overall volume.

According to one embodiment, preferably, a portion of the filter element housing, a housing of the inlet valve, a housing of the outlet valve, the bypass section and the inlet side pipe are integrally formed. The filter dryer component according to this embodiment enables simplification of the manufacturing and installation process.

According to one embodiment, preferably, a sealing ring member is arranged in the inlet valve near the bypass channel, so that when the inlet valve closes the fluid path to the bypass channel, the sealing ring member is able to form a seal with the surface of the ball of the inlet valve. The filter dryer component according to this embodiment enables preventing the refrigerant from flowing into the bypass channel when the refrigerant is flowing in the flow path passing through the filter element housing, so that all the refrigerant is filtered and dried through the filter element.

According to one embodiment, preferably, the end face of the filter element housing opposite to the end face where the fluid outlet is located is set as a cover, the rest of the filter element housing defining an open barrel, the cover being able to detachably fixed with the open barrel to form the filter element housing. The filter dryer component according to this embodiment enables maintenance personnel to easily disassemble the filter element housing, so as to put the filter element(s) into the filter element housing and to take out the filter element(s) from the filter element housing.

According to one embodiment, preferably, a bracket structure is attached to a side of the cover facing the open barrel, and the bracket structure is able to fix, detachably and side by side, one or more filter elements on said side of the cover, thereby forming an insertion assembly that is able to be integrally inserted into the open barrel. The filter dryer component according to this embodiment enables one or more filter elements to be easily inserted into or taken out of the filter element housing, thus facilitating the maintenance personnel to replace the filter element(s).

According to one embodiment, preferably, the bracket structure comprises one or more support members arranged at both ends of the one or more filter elements, and one or more rods passing through the one or more support members and attached to the cover, each support member is provided with one or more holes located near its center penetrating its both sides. The bracket structure on the filter dryer component according to this embodiment is formed by parts with simple structures, thereby reducing the weight and manufacturing cost of the entire filter dryer component.

According to one embodiment, preferably, the cover presents an arch shape protruding toward the outside of the filter element housing. The arch-shaped cover of the filter dryer component according to this embodiment enables the structure of the cover body to bear greater internal pressure of the housing, so the cover body is less prone to rupture due to the increase of internal pressure of the filter element housing.

According to one embodiment, preferably, the cover is provided with a maintenance hole, a maintenance bolt passing through the maintenance hole and sealing the maintenance hole. The filter dryer component according to this embodiment makes it possible to properly discharge the refrigerant in the filter element housing through the maintenance hole, thereby preventing the breakage of the filter element housing and other parts due to the increase of the internal pressure in the filter element housing.

According to one embodiment, preferably, the inner wall of the cylindrical cavity of the filter element housing is provided with a support protrusion radially supporting the filter elements. The filter dryer component according to this embodiment makes it possible to help the filter element(s) to be firmly fixed in the filter element housing, thereby improving the filtering and drying effect on the refrigerant.

According to one embodiment, preferably, the inlet valve and/or the outlet valve is provided with a rotation limiting mechanism, such that the stem of the inlet valve and/or the outlet valve is able to rotate only within a range of 90 degrees. The filter dryer component according to this embodiment enables that, when the inlet valve and/or the outlet valve is/are operated, the filter dryer can only be switched between the fluid path of the refrigerant passing through the filter element housing and the fluid path of the refrigerant passing through the bypass channel, thus facilitating the maintenance personnel to replace the filter element(s).

According to one embodiment, preferably, the filter element housing, the housing of the inlet valve, the housing of the outlet valve and the bypass section are separately manufactured parts, and the connections between the filter element housing, the inlet valve, the outlet valve and the bypass section are able to be disassembled. The filter dryer component according to this embodiment makes it easier to manufacture and replace various parts.

According to one embodiment, preferably, the ball of the inlet valve defines a T-shaped fluid channel, the T-shaped fluid channel defining two opposite fluid channel ports and one side fluid channel port, the volume of the ball opposite the side fluid channel port is provided with a discharge channel connecting the T-shaped fluid channel and the outside of the ball, and a decompression valve is provided in the discharge channel, the decompression valve only allowing fluid flow from the outside of the ball to the T-shaped fluid channel. The filter dryer component according to this embodiment enables that, during maintenance, the refrigerant in the filter element housing can flow into the bypass channel under the condition of excessive high pressure, so as to release pressure, while the refrigerant flowing in the bypass channel will not flow into the filter element housing, thus ensuring that the filter element replacement is carried out concurrent with the system operation.

According to a second aspect of the present invention. a filter dryer is proposed, which comprises the filter dryer component according to any one of the above-described filter dryer components and one or more filter elements installed in the filter element housing of the filter dryer component.

### BRIEF DESCRIPTION OF THE DRAWINGS

In order to illustrate the technical solutions of the embodiments of the present invention more clearly, the accompanying drawings of the embodiments of the present invention will be briefly introduced hereinafter. The accompanying drawings are only used to illustrate some embodiments of the present invention, but not to limit all the embodiments of the present invention thereto.

FIG. 1 is a perspective view of a filter dryer component according to one embodiment of the invention.

FIG. 2 is a cross-sectional view of a filter dryer component according to one embodiment of the invention in the working state, in which the filter elements are shown.

FIG. 3 is a cross-sectional view of a filter dryer component according to one embodiment of the invention in the maintenance state, in which the filter elements are shown.

FIG. 4 is a side view of a filter dryer component according to one embodiment of the invention, in which the rotation twist cover of the inlet valve is not shown.

FIG. 5 is a partial sectional view of a filter dryer component according to one embodiment of the invention, in which the inlet valve and its adjacent elements are shown.

FIG. 6 is a cross-sectional view of a filter dryer component according to one embodiment of the invention in the maintenance state, in which the filter elements fixed with the cover and not installed in place are shown.

FIG. 7 is a cross-sectional view of a filter dryer component according to another embodiment of the invention in the working state.

FIG. 8 is a perspective view of a filter dryer component according to yet another embodiment of the invention.

FIG. 9 is a side view of a filter dryer component according to yet another embodiment of the invention.

FIG. 10 is a cross-sectional view of a filter dryer component according to yet another embodiment of the invention in the working state.

FIG. 11 is a cross-sectional view of a filter dryer component according to yet another embodiment of the invention in the maintenance state.

FIG. 12 is a partial cross-sectional view of a filter dryer component according to yet another embodiment of the invention in the working state, in which the bypass section and adjacent elements are shown.

### DETAILED DESCRIPTION

In order to make the purpose, technical solution and advantages of the technical solutions of the present invention clearer, the technical solutions of the embodiments of the present invention will be clearly and completely described below with reference to the drawings of specific embodiments of the present invention. In the drawings, the same reference numerals represent the same elements. It should be noted that the described embodiments are part of the embodiments of the present invention, but not all of them. Based on the described embodiments of the present invention, all other embodiments obtained by those of skills in the art without creative labor are within the protection scope of the present invention.

Unless otherwise defined, the technical terms or scientific terms used here shall have their ordinary meanings as understood by those with ordinary skills in the field to which this invention belongs. The words “first”, “second” and the like used in the description and claims of the patent application of the present invention do not indicate any order, quantity or importance, but are only used to distinguish different components. Similarly, words “one” or “an” and the like do not necessarily mean quantity limitation. Words “comprising” or “including” and the like mean that the elements or objects appearing before the word cover the listed elements or objects appearing after the word and their equivalents, without excluding other elements or objects. Phrases like “connected to” or “connected with” are not limited to physical or mechanical connections, but can include electrical connections, whether direct or indirect. “Up”, “down”, “left” and “right” are only used to express relative positional relationship. When the absolute position of the described object changes, the relative positional relationship may also change accordingly.

The present invention will be described in detail below by describing example embodiments.

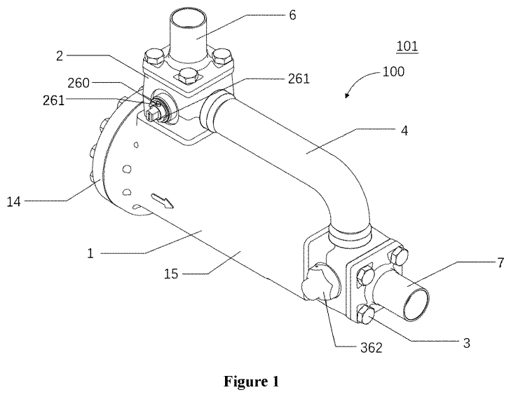

FIG. 1 is a perspective view of a filter dryer component 100 according to one embodiment of the invention. The filter dryer component 100 comprises a filter element housing 1, an inlet valve 2, an outlet valve 3, and a bypass section 4. The inlet valve 2 is arranged at the side face of the filter element housing 1, and the outlet valve 3 is arranged at one of the end faces of the filter element housing 1. The bypass section 4 is connected between the inlet valve 2 and the outlet valve 3. As shown in FIG. 1, the inlet valve 2 connects the filter element housing 1, the bypass section 4 and a fluid entry connector 6, and the outlet valve 3 connects the filter element housing 1, the bypass section 4 and a fluid exit connector 7. Generally, the filter element housing 1, the housing of the inlet valve 2, the housing of the outlet valve 3 and the bypass section 4 are separately manufactured parts, and the connection between the filter element housing 1, the inlet valve 2, the outlet valve 3 and the bypass section 4 can be disassembled to facilitate installation and maintenance.

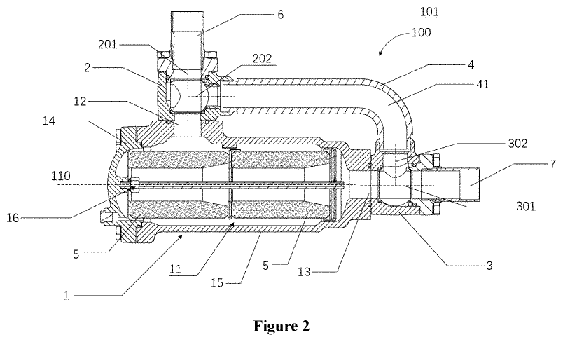

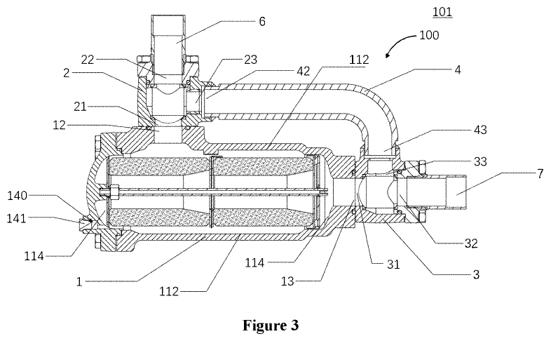

FIGS. 2 and 3 show cross-sectional views of the filter dryer component 100 of FIG. 1 in the working state and the maintenance state, respectively. According to the communication state of the inlet valve 2 and the outlet valve 3, the filter dryer component 100 can be switched between the working state and the maintenance state. Generally speaking, in the working state, as shown in FIG. 2, filter elements 5 are installed in the filter element housing 1, and fluid such as refrigerant enters the inlet valve 2 from the fluid entry connector 6, then enters the filter element housing 1, and is filtered by the filter elements 5, and then leaves the filter dryer component 100 through the outlet valve 3 and the fluid exit connector 7 successively. In this case, the filter dryer component 100 and the filter elements 5 placed therein together form a filter dryer 101. On the other hand, in the maintenance state, as shown in FIG. 3, the refrigerant enters the inlet valve 2 from the fluid entry connector 6, then enters the bypass channel 41 in the bypass section 4, and then directly reaches the outlet valve 3 and leaves the filter dryer component 100 via the fluid exit connector 7.

Next, with reference to FIGS. 2 and 3, the specific structure of the filter dryer component 100 will be further described.

As shown in FIGS. 2 and 3, the filter dryer component 100 has a filter element housing 1 with a cylindrical cavity 11 therein. In this embodiment, the cylindrical cavity 11 is generally cylindrical to match the shape of the filter elements. However, according to other embodiments, the cylindrical cavity 11 may have other column-like shapes. Back to the drawings, the cylindrical cavity 11 defines a cavity axis 110 (see FIG. 2), and defines a cavity side face 112 and two cavity end faces 114 (see FIG. 3). The filter element housing 1 has a fluid inlet 12 arranged on the cavity side face 112 and a fluid outlet 13 arranged on one cavity end face 114, which are respectively used for fluids such as refrigerant to enter and leave the filter element housing 1. In the working state of the filter dryer component 100, fluid such as refrigerant enters the filter element housing 1 through the fluid inlet 12, then enters the inner space of the filter elements 5 from the circumferential outside of the filter elements 5, being filtered and dried in the process of passing through the material of the filter elements 5. After that, fluid such as refrigerant flows from the inner space of the filter elements 5 to the fluid outlet 13 and then leaves the filter element housing 1. In addition, the inner wall of the cylindrical cavity 11 is provided with a support protrusion 1121 for radially supporting the filter elements 5, thereby keeping the filter elements 5 in place.

With continued reference to FIGS. 2 and 3, the filter element housing 1 comprises a cover 14 and an open barrel 15 which are fixed to each other. The cover 14 and the open barrel 15 are detachably fixed to each other by bolts, for example. In this case, the cover 14 mainly forms one cavity end face 114 of the filter element housing 1, and the open barrel 15 mainly forms the cavity side face 112 and the other cavity end face 114 of the filter element housing 1, thus making it convenient to open and close the filter element housing 1. However, according to other embodiments, the filter element housing 1 can also be formed by elements of other shapes fixed with each other. As shown in FIGS. 2 and 3, the cover 14 has an arch shape protruding toward the outside of the filter element housing 1, which makes the structure of the cover 14 more stable and less prone to rupture when the internal pressure of the filter element housing 1 rises. Optionally, the cover 14 has a maintenance hole 140 extending through both sides of the cover 14, and a maintenance bolt 141 is detachably arranged in the maintenance hole 140 and sealing the maintenance hole 140. During maintenance, the maintenance personnel can, after setting the inlet valve 2 and the outlet valve 3 to the maintenance state and before removing the cover 14, remove the maintenance bolt 141, so that fluid such as refrigerant can flow out of the filter element housing 1 through the maintenance hole 140, thus preventing the fluid pressure in the filter element housing 1 from being excessively high which results in the rupture of the filter element housing 1.

According to FIGS. 2 and 3, the inlet valve 2 is a T-shaped three-way valve with two opposite ports 21 and 22, as well as a side port 23. In this case, the port 21 is adjacently connected to the fluid inlet 12 of the filter element housing 1, the port 22 is connected to the fluid entry connector 6, and the side port 23 is adjacently connected to the entry port 42 of the bypass channel 41. The ball 25 in the inlet valve 2 has a T-shaped fluid channel which defines two opposite fluid channel ports and one side fluid channel port. On the other hand, the outlet valve 3 is also a T-shaped three-way valve with two opposite ports 31 and 32, as well as a side port 33. In this case, the port 31 is adjacently connected to the fluid outlet 13 of the filter element housing 1, the port 32 is connected to the fluid exit connector 7, and the side port 33 is adjacently connected to the exit port 43 of the bypass channel 41. The ball in the outlet valve 3 has a T-shaped fluid channel which defines two opposite fluid channel ports and one side fluid channel port.

It should be noted that, for the embodiment shown in FIGS. 2 and 3, the filter element housing 1, the inlet valve 2, the outlet valve 3 and the bypass section 4 of the filter dryer component 100 generally forms a rectangular shape in one plane. Specifically, the spatial positions of the elements defined in FIGS. 2 and 3 are described as follows.

First of all, the inlet valve 2 and the outlet valve 3 respectively define their respective central linear axes 201, 301 connecting two opposite ports, and side axes 202, 302 connecting the centers of their respective side ports and perpendicular to their respective central linear axes. Thus, the port 21 of the inlet valve 2 is adjacently connected to the fluid inlet 12 of the filter element housing 1, the linear axis 201 of the inlet valve 2 is generally perpendicular to and intersects the cavity axis 110 of the filter element housing 1, the side port 23 of the inlet valve 2 is arranged toward the side where the fluid outlet 13 of the filter element housing 1 is located, and the side axis 202 of the inlet valve 2 is generally parallel to the cavity axis 110 of the filter element housing 1. The port 31 of the outlet valve 3 is adjacently connected to the fluid outlet 13 of the filter element housing 1, the linear axis 301 of the outlet valve 3 is generally parallel to the cavity axis 110 of the filter element housing 1, the side port 33 of the outlet valve 3 is arranged toward the side where the fluid inlet 12 of the filter element housing 1 is located, and the side axis 302 of the outlet valve 3 is generally parallel to the linear axis 201 of the inlet valve 2. The entry port 42 of the bypass channel 41 is adjacently connected to the side port 23 of the inlet valve 2, and the exit port 43 of the bypass channel 41 is adjacently connected to the side port 33 of the outlet valve 3. The bypass channel 41 extends in the plane formed by the cavity axis 110 of the filter element housing 1 and the linear axis 201 of the inlet valve 2.

The filter dryer component 100 described above and shown in FIGS. 2 and 3 has the advantages of ordered structure and easy manufacture. However, the filter dryer component 100 according to an embodiment of the invention may be arranged not according to the above-mentioned element position relationship, and it only needs to conform to the respective definition of each element and the mutual connection relationship between the elements.

As shown in FIG. 2, when the filter dryer component 100 is in the working state, the two opposite fluid channel ports of the ball 25 of the inlet valve 2 are respectively located at the opposite ports 21 and 22, and the side fluid channel port of the ball 25 of the inlet valve 2 is located at the opposite position to the side port 23, so only the ports 21 and 22 are in fluid communication. Meanwhile, the two opposite fluid channel ports of the ball of the outlet valve 3 are respectively located at the opposite ports 31 and 32, and the side fluid channel port of the ball of the outlet valve 3 is located at the side port 33, so the ports 31 and 32 and the side port 33 are in fluid communication. Therefore, when the filter dryer component 100 is in the working state, fluid such as refrigerant entering the filter dryer component 100 will enter the filter element housing 1 through the fluid inlet 12 of the filter element housing 1, be filtered and dried by the filter elements 5, and then leave the filter element housing 1 through the fluid outlet 13. It should be noted that the ports 31, 32, and 33 of the outlet valve 3 are all in fluid communication, which makes the bypass channel 41 in the bypass section 4 not form a space with closed ends, thereby preventing the pressure of fluid such as refrigerant from undesirably increasing in the closed space and breaking the elements.

As shown in FIG. 3, when the filter dryer component 100 is in the maintenance state, one of the two opposite fluid channel ports of the ball 25 of the inlet valve 2 is located at the side port 23, and the side fluid channel port of the ball 25 of the inlet valve 2 is located at the port 22, so only the port 22 and the side port 23 are in the fluid communication state. Meanwhile, one of the two opposite fluid channel ports of the ball of the outlet valve 3 is located at the port 33 and the side fluid channel port of the ball of the outlet valve 3 is located at the port 32, so that only the port 32 and the side port 33 are in the fluid communication state. Therefore, when the filter dryer component 100 is in the maintenance state, all of the fluid such as refrigerant entering the filter dryer component 100 will enter the bypass channel 41 through the entry port 42 of the bypass channel 41, and then leave the bypass channel 41 through the exit port 43 of the bypass channel 41, and finally leave the filter dryer component 100. In addition, in the maintenance state, fluid, such as refrigerant, in the bypass channel 41 cannot enter the filter element housing 1, thus ensuring the maintenance work of the maintenance personnel and the operation of the system at the same time.

According to an embodiment not shown, a volume of the ball 25 of the inlet valve 2 opposite to the side fluid channel port is provided with a discharge channel which communicates the T-shaped fluid channel of the inlet valve 2 with the outside of the ball 25. A decompression valve is provided in the discharge channel, which only allows fluid flow from the outside of the ball 25 to the T-shaped fluid channel. In the maintenance state of the filter dryer component 100, the volume of the ball 25 of the inlet valve 2 opposite to the side fluid channel port is located at the port 21 and closing the port 21. Therefore, if the pressure of the fluid such as refrigerant in the filter element housing 1 is too high, some of the refrigerant can flow into the T-shaped fluid channel of the inlet valve 2 through the decompression valve, thus entering the fluid path passing through the bypass channel 41. This makes it possible to protect the filter element housing 1 from rupture caused by excessively high pressure. On the other hand, the fluid such as refrigerant flowing in the inlet valve 2 still cannot enter the filter element housing 1, thus facilitating the maintenance personnel to replace the filter elements 5.

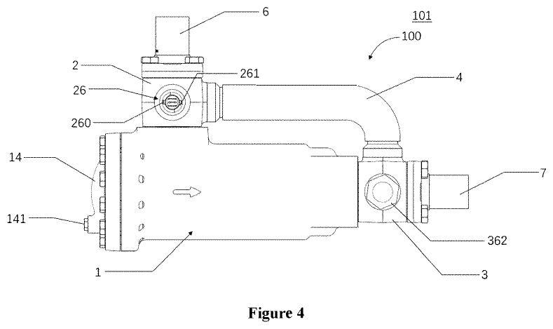

FIG. 4 shows a side view of a filter dryer component 100 according to one embodiment of the present invention, especially the side views of the inlet valve 2 and the outlet valve 3. According to this embodiment, the inlet valve 2 and the outlet valve 3 have rotation limiting mechanisms 26 and 36, respectively. FIG. 4 shows the rotation limiting mechanism 26 of the inlet valve 2. The rotation limiting mechanism 26 comprises a rotation protrusion 260 and a rotation limiting member 261. In this embodiment, the rotation protrusion 260 is a protrusion extending radially outward from the valve stem of the inlet valve 2, and the inlet valve 2 has two diametrically opposite rotation protrusions 260. The rotation limiting member 261 is arranged on the outer surface of the inlet valve 2 and around the valve stem. The rotation limiting member 261 has two diametrically opposite-arranged recesses extending 90 degrees in the circumferential direction, and the two rotation protrusions 260 are respectively limited in the two recesses. Therefore, the valve stem of the inlet valve 2 can only rotate within a range of 90 degrees, so that the ball 25 of the inlet valve 2 can only rotate within a range of 90 degrees. According to this embodiment, the rotation limiting mechanism 36 of the outlet valve 3 may have the same structure as the rotation limiting mechanism 26. FIG. 4 also shows a rotation twist cover 362 covering the rotation limiting mechanism 36 of the outlet valve 3. The rotation twist cover 362 facilitates the maintenance personnel to twist the valve stem. In addition, the inlet valve 2 also has a rotation twist cover covering the rotation limiting mechanism 26.

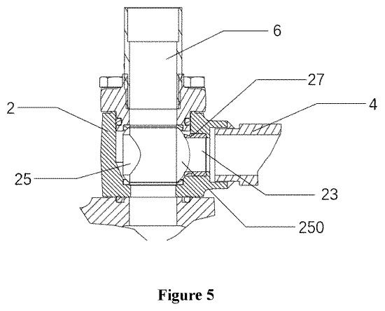

FIG. 5 shows an enlarged view of the filter dryer component 100 of the previous embodiment near the inlet valve 2. In this case, a sealing ring member 27 located in the inlet valve 2 is shown. The sealing ring member 27 is arranged in the inlet valve 2 near the bypass channel 41, so that the sealing ring member 27 forms a seal with the surface 250 of the ball 25 of the inlet valve 2 when the inlet valve 2 closes the fluid path leading to the bypass channel 41. According to one embodiment, the sealing ring member 27 is a cylindrical hollow annular part, which is arranged in the side port 23 of the inlet valve 2, around the annular inner wall of the side port 23, and extends and protrudes toward the sphere 25 of the inlet valve 2 to form an annular protruding portion. Therefore, when the surface 250 of the ball 25 turns toward the side port 23, the annular protruding portion of the sealing ring member 27 can contact and press the ball surface 250 to form a seal, so that the fluid such as refrigerant will not enter the inlet valve 2 from the bypass channel 41. The sealing ring member 27 can be made of elastic material, such as rubber, so as to achieve better sealing effect.

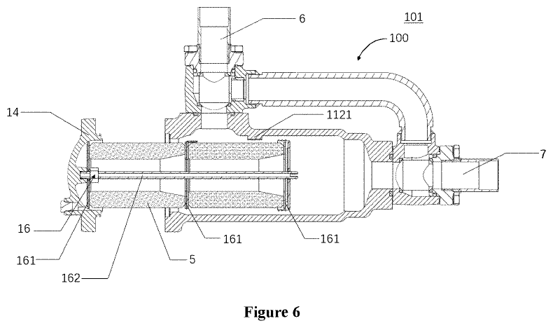

FIG. 6 shows a cross-sectional view of the filter dryer component 100 according to the above embodiment in the maintenance state. In FIG. 6, the cover 14 is separated from the open barrel 15, for example, by loosening the bolt connection between the cover 14 and the open barrel 15.

FIG. 6 also shows the filter elements 5 fixed with the cover 14 and not installed in place. In this embodiment, two filter elements 5 are fixed on the cover 14 side by side by a bracket structure 16. The support structure 16 comprises support members 161 and a rod 162. When the filter elements 5 are fixed on the cover 14, the support members 161 are located at both axial ends of each filter element 5 for supporting the filter elements. The rod 162 sequentially passes through the support members 161 and the filter element 5 arranged together. In addition, the support members 161 can be detachably fixed to the rod 162, which can in turn be fixed to the cover 14. Thus, the bracket structure 16 and the filter elements 5 form an insertion assembly that can be integrally inserted into the open barrel. After the insertion assembly is taken out of the open barrel 15, the filter elements 5 can be replaced by removing the fixing connection between the support members 161 and the rod 162. Then, new filter elements 5 forms an insertion assembly with the support members 161 and the rod 162, and is inserted into the open barrel 15. In addition, hole(s) penetrating both sides are provided near the center of the support members 161, so that the filtered and dried fluid such as refrigerant can flow between the internal spaces of the filter elements 5 and flow out from the internal spaces of the filter elements 5 to reach the fluid outlet 13 of the filter element housing 1.

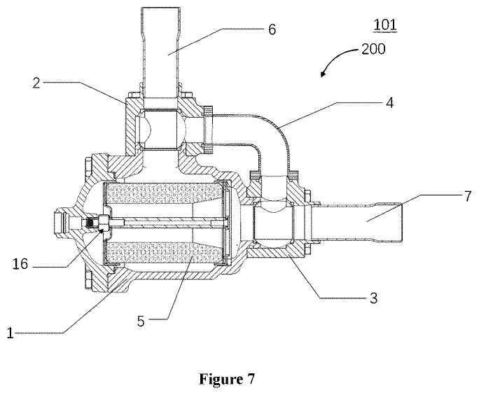

FIG. 7 shows a filter dryer component 200 according to another embodiment of the present invention. Other structures of this embodiment are the same as those of the embodiment shown in FIGS. 1 to 6, except that this another embodiment has only one filter element 5. The one filter element 5 is still fixed on a bracket structure 16 and placed in the filter element housing 1. The respective structures and relationships of the filter element housing 1, the inlet valve 2, the outlet valve 3 and the bypass section 4 refer to the description of the previous embodiments. The filter dryer component 200 with only one filter element 5 has smaller volume and lower cost on the basis of the aforementioned advantages. However, according to other embodiments, the filter dryer component according to the present invention can also have more than two filter elements 5 according to actual needs.

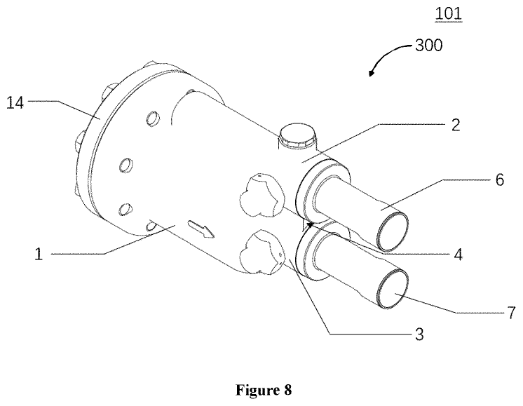

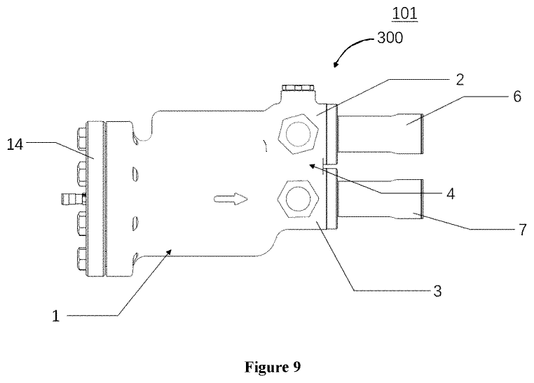

FIGS. 8 and 9 show a filter dryer component 300 according to yet another embodiment of the present invention. The filter dryer component 300 of this embodiment is basically formed as an integral part, except for the cover 14 of the filter element housing 1. That is, the open barrel 15 of the filter element housing 1, the housing of the inlet valve 2, the housing of the outlet valve 3, and the bypass section 4 are integrally formed in this embodiment. According to other embodiments, a portion of the filter element housing 1 is integrated with the housing of the inlet valve 2, the housing of the outlet valve 3 and the bypass section 4, while the rest of the filter element housing 1 can be detachably fixed with the aforementioned portion of the filter element housing 1 to form the whole filter element housing 1.

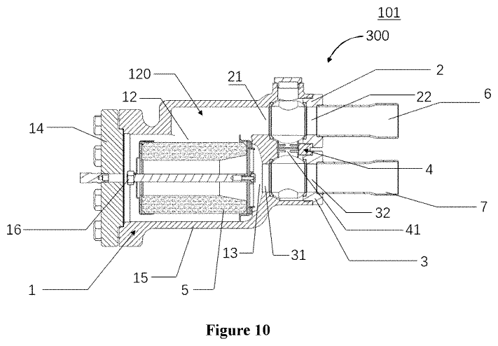

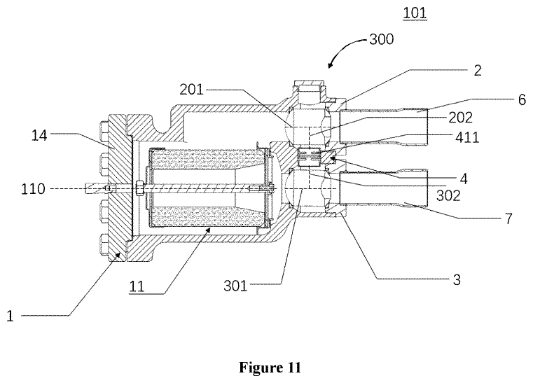

FIGS. 10 and 11 show cross-sectional views of a filter dryer component 300 of the yet another embodiment shown in FIGS. 8 and 9. In FIG. 10, the filter dryer component 300 is in the working state, and in FIG. 11, the filter dryer component 300 is in the maintenance state.

As shown in FIGS. 10 and 11, the internal structures of the inlet valve 2 and outlet valve 3 of the filter dryer component 300 are the same as those of the aforementioned filter dryer components 100 and 200, but the positions of the inlet valve 2 and the bypass section 4 are different. The specific arrangement of the filter dryer component 300 is as follows. One of the two opposite ports 31 of the outlet valve 3 is adjacently connected to the fluid outlet 13 of the filter element housing 1, the linear axis 301 of the outlet valve 3 is generally parallel to the cavity axis 110 of the filter element housing 1, and the side port 33 of the outlet valve 3 is arranged toward the side where the fluid inlet 12 of the filter element housing 1 is located. The inlet valve 2 is arranged such that the side port 23 of the inlet valve 2 and the side port 33 of the outlet valve 3 are close to and facing each other, the linear axis 201 of the inlet valve 2 is generally parallel to the cavity axis 110 of the filter element housing 1, the bypass section 4 is arranged between the inlet valve 2 and the outlet valve 3, and the side port 23 of the inlet valve 2 and the side port 33 of the outlet valve 3 are in communication with each other via the bypass channel 41. In addition, the filter dryer component 300 further has an inlet side pipe 120 provided outside the filter element housing 1, and the inlet side pipe 120 communicates the fluid inlet 12 of the filter element housing 1 with the port 21 of the inlet valve 2.

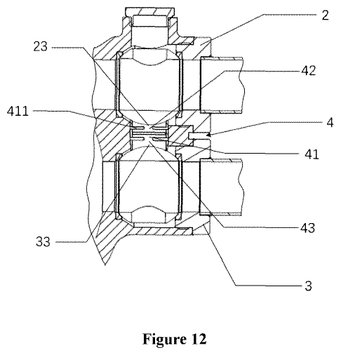

FIG. 12 shows the bypass section 4 of the filter dryer component 300 and its adjacent elements. Due to the positions of the inlet valve 2 and the outlet valve 3, in the filter dryer component 300, the length of the bypass channel 41 is shorter than that of the bypass channel of the filter dryer components 100 and 200. A sealing ring member 411 is provided in the bypass channel 41.

Back to FIGS. 10 and 11, the working state and the maintenance state of the filter dryer component 300 will be introduced.

In the working state shown in FIG. 10, the inlet valve 2 is set so that only the opposite ports 21 and 22 are in fluid communication state, and the outlet valve 3 is set so that only the opposite ports 31 and 32 are in fluid communication state, while both side ports 23 and 33 are closed. Therefore, fluid such as refrigerant entering the filter dryer component 300 successively flows through the inlet valve 2 and the inlet side pipe 120, and enters the periphery of the filter element 5 in the filter element housing 1. Then, fluid such as refrigerant passes through the material of the filter element 5 and enters the inner space of the filter element 5, and is filtered and dried in the process. Then, fluid such as refrigerant reaches the outlet valve 3 via the fluid outlet 13, so as to leave the filter dryer component 300.

In the maintenance state shown in FIG. 11, the inlet valve 2 is set so that only the port 22 and the side port 23 are in fluid communication state, and the outlet valve 3 is set so that only the port 32 and the side port 33 are in fluid communication state, while both ports 21 and 31 are closed. Therefore, fluid such as refrigerant entering the filter dryer component 300 directly enters the bypass channel 41 in the bypass section 4 through the inlet valve 2, and then leaves the filter dryer component 300 through the outlet valve 3. The refrigerant flowing in this fluid path will not enter the filter element housing 1, so the maintenance personnel can separate the cover 14 from the open barrel 15, and meanwhile remove the support structure 16 and the filter element 5 formed as insertion assembly, and replace the filter element 5.

The exemplary embodiments of the filter dryer components and the filter dryers proposed by the present invention are described in detail above with reference to the preferred embodiments. However, those skilled in the art can understand that on the premise of not departing from the concept of the present invention, various changes and modifications can be made to the above specific embodiments, and various technical features and structures proposed by the present invention can be combined in various ways without exceeding the scope of protection of the present invention.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A filter dryer component comprising a filter element housing, an inlet valve, an outlet valve and a bypass section, wherein the filter element housing has a fluid inlet and a fluid outlet, one or more filter elements being able to detachably installed in the filter element housing,
the bypass section has a bypass channel therein, the bypass channel having an entry port and an exit port in communication with each other,
the inlet valve and the outlet valve are both T-shaped three-way ball valves, the inlet valve and the outlet valve each defining two opposite ports and one side port a connecting line between the center points of the two opposite ports defining a linear axis, and the center point of the side port defining a side axis that is generally perpendicular to and intersects the linear axis, and wherein,
the two opposite ports of the inlet valve are respectively connected to a fluid entry connector and the fluid inlet of the filter element housing, and the side port of the inlet valve is connected to the entry port of the bypass channel,
the two opposite ports of the outlet valve are respectively connected to a fluid exit connector and the fluid outlet of the filter element housing, and the side port of the outlet valve is connected to the exit port of the bypass channel.

2. The filter dryer component according to claim 1, wherein the filter element housing has a cylindrical cavity, the cylindrical cavity defining a cavity side face and two cavity end faces the central axis of the cylindrical cavity defining a cavity axis and wherein the fluid inlet of the filter element housing is arranged at the cavity side face and the fluid outlet of the filter element housing is arranged at one of the cavity end faces.

3. The filter dryer component according to claim 2, wherein one of the two opposite ports of the inlet valve is adjacently connected to the fluid inlet of the filter element housing, the linear axis of the inlet valve is generally perpendicular to and intersects with the cavity axis of the filter element housing, the side port of the inlet valve is arranged toward the side where the fluid outlet of the filter element housing is located, and the side axis of the inlet valve is generally parallel to the cavity axis of the filter element housing;
one of the two opposite ports of the outlet valve is adjacently connected to the fluid outlet of the filter element housing, the linear axis of the outlet valve is generally parallel to the cavity axis of the filter element housing, the side port of the outlet valve is arranged toward the side where the fluid inlet of the filter element housing is located, and the side axis of the outlet valve is generally parallel to the linear axis of the inlet valve;
the entry port of the bypass channel is adjacently connected to the side port of the inlet valve, and the exit port of the bypass channel is adjacently connected to the side port of the outlet valve, and the bypass channel extends in the plane formed by the cavity axis of the filter element housing and the linear axis of the inlet valve.

4. The filter dryer component according to claim 2, wherein one of the two opposite ports of the outlet valve is adjacently connected to the fluid outlet of the filter element housing, the linear axis of the outlet valve is generally parallel to the cavity axis of the filter element housing, and the side port of the outlet valve is arranged toward the side where the fluid inlet of the filter element housing is located;
wherein the inlet valve is arranged such that the side port of the inlet valve and the side port of the outlet valve are close to and facing each other, the linear axis of the inlet valve is generally parallel to the cavity axis of the filter element housing, and the bypass section is arranged between the inlet valve and the outlet valve, the side port of the inlet valve and the side port of the outlet valve in communication with each other via the bypass channel;
and wherein, the filter dryer component has an inlet side pipe arranged outside the filter element housing, the inlet side pipe communicating the fluid inlet of the filter element housing with one of the two opposite ports of the inlet valve that is closer to the fluid inlet of the filter element housing.

5. The filter dryer component according to claim 4, wherein a portion of the filter element housing, a housing of the inlet valve, a housing of the outlet valve, the bypass section and the inlet side pipe are integrally formed.

6. The filter dryer component according to claim 1, wherein a sealing ring member is arranged in the inlet valve near the bypass channel, so that when the inlet valve closes the fluid path to the bypass channel, the sealing ring member is able to form a seal with the surface of the ball of the inlet valve.

7. The filter dryer component according to claim 1, wherein that the end face of the filter element housing opposite to the end face where the fluid outlet is located is set as a cover, the rest of the filter element housing defining an open barrel, the cover being able to detachably fixed with the open barrel to form the filter element housing.

8. The filter dryer component according to claim 7, wherein a bracket structure is attached to a side of the cover facing the open barrel, and the bracket structure is able to fix, detachably and side by side, one or more filter elements on said side of the cover, thereby forming an insertion assembly that is able to be integrally inserted into the open barrel.

9. The filter dryer component according to claim 8, wherein the bracket structure comprises one or more support members arranged at both ends of the one or more filter elements, and one or more rods passing through the one or more support members and attached to the cover, each support member is provided with one or more holes located near its center penetrating its both sides.

10. The filter dryer component according to claim 7, wherein the cover presents an arch shape protruding toward the outside of the filter element housing.

11. The filter dryer component according to claim 7, wherein the cover is provided with a maintenance hole a maintenance bolt passing through the maintenance hole and sealing the maintenance hole

12. The filter dryer component according to claim 1, wherein that the inner wall of the cylindrical cavity of the filter element housing is provided with a support protrusion radially supporting the filter elements.

13. The filter dryer component according to claim 1, wherein the inlet valve and/or the outlet valve is provided with a rotation limiting mechanism such that the stem of the inlet valve and/or the outlet valve is able to rotate only within a range of 90 degrees.

14. The filter dryer component according to claim 3, wherein the filter element housing, the housing of the inlet valve, the housing of the outlet valve and the bypass section are separately manufactured parts, and the connections between the filter element housing, the inlet valve, the outlet valve and the bypass section are able to be disassembled.

15. The filter dryer component according to claim 1, wherein the ball of the inlet valve defines a T-shaped fluid channel, the T-shaped fluid channel defining two opposite fluid channel ports and one side fluid channel port, the volume of the ball opposite the side fluid channel port is provided with a discharge channel connecting the T-shaped fluid channel and the outside of the ball, and a decompression valve is provided in the discharge channel, the decompression valve only allowing fluid flow from the outside of the ball to the T-shaped fluid channel.

16. A filter dryer comprising the filter dryer component according to claim 1 and one or more filter elements installed in the filter element housing of the filter dryer component.
